(19) United States
(12) Patent Application Publication
(10) Pub. No.: US 2009/0314626 A1
(43) Pub. Date: Dec. 24, 2009

(54) METHOD FOR TREATING EFFLUENTS CONTAINING FLUOROCOMPOUNDS LIKE PFC AND HFC

(76) Inventors: Pascal Moine, Groisy (FR); Hervé Dulphy, Jarrie (FR); Christian Larquet, Guyancourt (FR); Aicha El-Krid, Saint Denis (FR); Daniel Guerin, Chelles (FR); Jean-Christophe Rostaing, Versailles (FR); Anne-Laure Lesort, Gien (FR); Etienne Sandre, Paris (FR)

Correspondence Address: AIR LIQUIDE;Intellectual Property, 2700 POST OAK BOULEVARD, SUITE 1800, HOUSTON, TX, 77056, US

(21) Appl. No.: 12/281,303

(22) PCT Filed: Feb. 26, 2007
(86) PCT No.: PCT/EP07/51811

§ 371 Date: Sep. 1, 2009

(30) Foreign Application Priority Data
Mar. 3, 2006 (FR) 0650761

(51) Int. Cl. B01D 53/32; B01D 53/70; B01J 19/08

(52) U.S. Cl. 204/157.3

(57) ABSTRACT

The invention relates to a method for destroying effluents issuing from a reactor, the said effluents being transported through at least one pump towards plasma means capable of destroying at least certain bonds in the molecules of the PFC or HFC type between the fluorine and the other elements of these molecules of the PFC or HFC type, in order to generate first species which are then converted to second gaseous, liquid or solid species before interaction of these second species with dry or wet purifying means. According to the invention, at least one reducing agent is injected upstream and/or downstream of the plasma, but upstream of the purifying means, in order to react with the first species created.

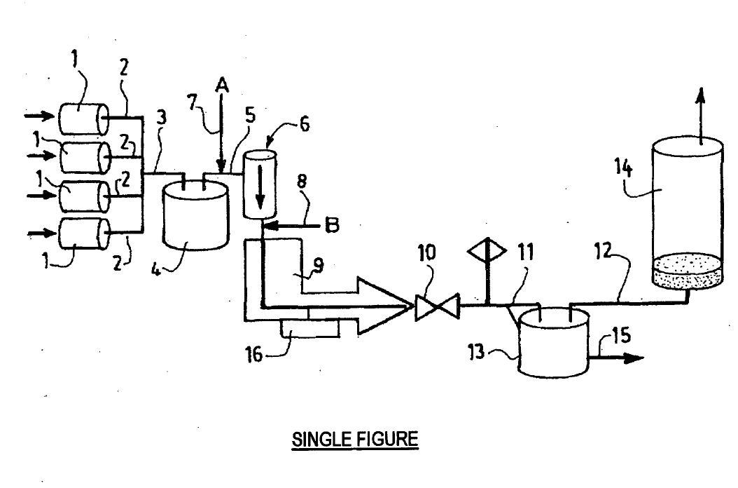

The present invention relates to a method for destroying effluents issuing from a reactor, the said effluents being transported through at least one pump towards plasma means capable of destroying at least certain bonds in molecules of the perfluorinated (PFC) or hydrofluorocarbon (HFC) type, between the fluorine and the other elements of these molecules, in order to generate first species which are then converted to second gaseous, liquid or solid species before interaction of these second species with dry or wet purifying means.

Various systems for destroying fluorine-containing compounds issuing from reactors for etching or chemical vapour deposition of thin films, particularly in semiconductor production units, are known in the literature. See for example U.S. Pat. No. 5,965,786. (These fluorine-containing compounds may be used for etching existing films, for depositing new films, for cleaning the reactors used for this etching or deposition, for example.)

In these known systems, oxygen or air is usually injected into the gas containing PFCs or HFCs before their introduction into the plasma, in order to generate products such as F₂, COF₂, SO₂F₂, SOF₄, etc. at the plasma outlet. However, these products are themselves difficult to destroy subsequently, and today, a person skilled in the art would wish to obtain, at the plasma outlet, products that are easier and less costly to destroy, particularly products which can be withdrawn from the offgases leaving the plasma by a simple water scrubbing (or other solution well known per se to a person skilled in the art, such as amines, etc.).

A person skilled in the art thereby wishes to be able to use these scrubbing systems, which may optionally be centralized or delocalized, and/or solid reactive adsorbents that are more common and less costly than those required in the case of oxygen conversion chemistry.

Today, in the effluent destruction systems used at the exit of an etching machine, and after the pumps, conveying the product issuing from the etching chamber (cleaning or etching) at atmospheric pressure, oxygen is injected just before the entry of these effluents into the plasma system, and the abovementioned species are recovered and partially removed with a “dry” pollution control system (generally solid alkali reactive adsorbents) optionally followed by a wet pollution control system.

However, the system for cooling the gases issuing from the plasma system, in a heat exchanger, directly to a temperature of about 20° C., causes the creation of solid particles which may clog the system.

In other alternative embodiments, the gases issuing from a CVD type of deposition chamber, particularly after the cleaning of the chamber using products of the PFC or HFC type which follows the deposition step, are treated at the outlet of the primary pumps in a plasma system after oxygen injection just before the introduction of these gases into the plasma, the wastes issuing from the plasma being sent successively through a dry pollution control system then a wet pollution control system or scrubber.

In all known systems today, however, solid carbon-containing products which tend to clog the system are generated by reaction between the oxidizing product (O₂, air) added to the gases to be treated.

It has also been found that, by operating these plasma systems to treat certain effluents by a thin film etching method that, inexplicably, particularly when dielectric tubes are used to confine the plasma reaction, in an approach such as described in U.S. Pat. No. 5,965,786, the said dielectric tubes were liable to break suddenly and virtually instantaneously, without any possibility of preventing this occurrence, thereby causing failure and immediate shutdown of the system for treating gaseous effluents by the plasma, thereby reducing the system's mean time between failures (MTBF).

The cause of this problem has been difficult to identify because the pollution control equipment manufacturer does not know exactly which products are contained in the effluents, which often vary during acceptance procedures, particularly when the semiconductor manufacturer tests new products.

After intensive research, and generally in the absence of manufacturing acceptance and hence of the content of the effluents, it has appeared that certain metal compounds could be deposited on the walls of the dielectric tube (when a confined plasma is used in a dielectric tube) or of the chamber in general, and form a conducting layer, which, in the case of dielectric tubes particularly, leads to the virtually immediate shutdown of the apparatus, because this deposition makes the tube wall highly absorbent to microwaves.

One possible explanation could be in particular the incompatibility of certain materials with the water vapour or other oxidizing elements mixed with the gas to be treated before its introduction into the plasma.

To solve the first problem that the invention proposes to solve, that is, essentially how to use a scrubbing system (wet) to scrub the effluents (the second species) issuing from the plasma, the invention recommends injecting chemical compounds in which the molecule contains at least one hydrogen atom, preferably at the plasma outlet or, as early as possible, in the plasma but close to the outlet of these compounds from the plasma, essentially to generate hydrofluoric acid which then dissolves in the water (or any reducing liquid system), without being obliged to use a “dry” pollution control system to remove the hydrofluoric acid (all things considered, the user will sometimes prefer to use this “dry” system in addition as a precautionary measure).

The inventors have also found that when, in particular, products such as WF₆ are found in the reactor, the passage of this gas through the plasma, accompanied by a partially reducing or hydrogen-containing element, causes the deposition of W on the tube walls, thereby causing its virtually instantaneous failure.

In order to solve this second problem posed by the use of hydrogen-containing additives when the first species particularly comprise a metal fluorine derivative such as WF₆ capable of generating a metal deposit and when the plasma is produced in a dielectric tube, it is then important to inject at least one hydrogen-containing element downstream of the plasma, preferably just at the outlet thereof, so that this hydrogen-containing element reacts as soon as possible with the first species created in the plasma from the mixture containing the PFC to generate second species. (As an equivalent, this hydrogen-containing element or reducing agent can be injected into the plasma itself, at a place such that the PFC or HFC molecules have already been “broken” or partially “broken”, preferably in the location called the plasma post-discharge zone).

When a compound such as WF₆ is present in the offgases, at the plasma inlet, the decomposition of this product in the plasma is thereby avoided. On the contrary, the first species issuing from WF₆ will then react upon leaving the plasma with the reducing species injected downstream, causing a deposition of tungsten metal or other solid tungsten compounds, such as oxides or oxyfluorides, on the generally metal lines located at the plasma outlet, thereby raising no problem of operation of the plasma system.

As a source, particularly gaseous, of hydrogen-containing reagent and/or reducing agent, use can be made of H₂O, H₂, CH₄, NH₃, alcohols like methanol, ethanol etc., glycols, hydrocarbons, hydrides, or any other hydrogen-containing compounds.

It has in fact been found that the second species thereby created (using these hydrogen-containing additives) contained much more hydrofluoric acid HF than when anhydrous additives were used, particularly of the oxygen-containing type. Furthermore, when WF₆ (or similar products) is/are present randomly in the effluents to be treated and issuing from the reactors placed upstream of the pumps, the downstream injection (with regard to the plasma) of hydrogen-containing products causes a deposition of W (or of derivatives of W) in the lines located downstream of the plasma, lines which are generally made from stainless steel or plastic, and for which such a deposit, which is obviously very thin, is absolutely not a drawback.

However, it has been found that if hydrogen-containing compounds were only to be injected downstream of the plasma, without adding anything to the offgases upstream, the solution obtained is not fully satisfactory. In fact, the destruction efficiency obtained in this case is lower, all other things remaining equal, than would be obtained by introducing the same quantity of hydrogen-containing additive gas, for example, water vapour, upstream of the plasma.

The inventors believe that a significant proportion of the PFCs initially introduced into the plasma has probably been reconstituted before their decomposition fragments can react with the hydrogen-containing compounds introduced downstream. The PFCs thus reconstituted can no longer be dissociated again before leaving the plasma-filled zone.

In order to simultaneously solve the two problems posed above, according to a preferable embodiment, the invention consists in injecting upstream of the plasma or at the very latest into it, preferably gaseous oxygen-containing compounds not comprising any atoms of hydrogen or other elements capable of reacting with metal elements such as Al, W, etc. (if present in the plasma), while injecting hydrogen-containing compounds downstream of the plasma, into the mixture of the first gaseous species generated by the chemical conversion in the plasma, where the temperature of the first gaseous species issuing from the plasma preferably remains equal to or higher than 150° C., so that these hydrogen-containing compounds react with the first species.

Without wishing to be tied to any particular theory, the inventors believe that when an anhydrous additive, particularly oxygen, for example oxygen or air, is injected upstream of the plasma, the said additive will be dissociated and/or excited and its fragments will react very easily with the dissociation fragments of the PFCs and/or HFCs to yield corrosive fluorine-containing compounds such as F₂, COF₂, SO₂F₂, SOF₄: (the first species): these compounds are very stable at the high temperature of the gas in the microwave plasma and, once formed, are very unlikely to be dissociated again. In particular, they are not significantly reconverted to PFC. These corrosive anhydrous fluorine-containing products such as F₂, COF₂, SO₂F₂, SOF₄ are much more reactive than PFCs. At the plasma outlet, when the hydrogen-containing compounds are injected, the temperature is still sufficient for them to react more or less completely with the hydrogen-containing additives, to essentially produce HF which is much more stable thermodynamically than the corrosive anhydrous fluorine-containing compounds. However, the PFCs that have not been converted by the plasma will not react significantly with these hydrogen-containing additives leaving the plasma. Thus, the PFC conversion yield is substantially the same as that of the pollution control method using as additive only the non-hydrogen containing, particularly oxygen-containing compound(s), injected upstream of the plasma.

The invention will be better understood from the following exemplary embodiments which are non-limiting, in conjunction with the single figure which shows a schematic view of an effluent treatment system of the invention.

The reactors for manufacturing semiconductors (not shown in the figure), which operate under vacuum, are connected to pumps of which the figure only shows the primary pumps 1 which deliver an effluent at atmospheric pressure at the outlet 2.

Several pumps 1 connected to various reactors are connected in parallel, in order to simultaneously treat the effluents issuing from reactors which may execute various steps of the method (deposition, etching, reactor cleaning, etc.).

A first particle filter 4 is provided before the introduction of these gases via 5 into the plasma system 6 (which may be any plasma system for destroying effluents, particularly a system as described in U.S. Pat. No. 5,965,786).

At the outlet of the plasma system 6, heat exchange means 9 are arranged to cool the treated gases, with, in the bottom part of these means 9, means 16 for recovering liquids that may have condensed in these means 9 or solids that may have been formed upstream or in the means 9.

After passage through the valve 10 in order to isolate the plasma from (its discharge line) downstream if necessary, the low temperature gases reach, via the line 11, an additional trap 13 (optional, depending on the methods) to optionally condense residual products or to trap any solids which are removed at 15, while the remaining offgases flow via the line 12 into dry or wet means 14 for trapping gaseous products, means known per se to a person skilled in the art.

According to the invention, elements other than the oxidizing elements are injected at points A (7) upstream of the plasma 6 and/or B downstream of the plasma 6 while at least one oxidizing element is optionally (but not necessarily) injected into the plasma means 6, as explained above.

If the effluents in the line 5 do not contain any gaseous compound, for example WF₆, of a metal capable, by passage through the plasma, of generating a metal deposit on the walls of the chamber where the plasma is generated, then any hydrogen-containing gaseous product and/or reducing agent can be injected upstream of the plasma, including products containing both oxygen and hydrogen, without the risk of metal deposition inside the means 6 which generate the plasma. The injection of exclusively hydrogen-containing reagent and/or reducing agent issuing from the plasma can be maintained, reduced or discontinued.

If, on the contrary, the effluents contain at least one gaseous compound of at least one metal (for example WF₆), then at least one anhydrous oxygen-containing element (oxygen, air, nitrogen), is injected upstream of the plasma, into the effluent to be treated, while at least one hydrogen-containing additive and/or reducing agent is injected preferably downstream of the plasma (or as early as possible into the plasma or into the post-discharge zone) into the mixture of first species created. (In case of uncertainty concerning this injection, it is preferable to use this second solution).

It is then possible to inject, downstream of the plasma, at least one reducing additive such as H₂0, H₂, CH₄, NH₃, alcohols such as methanol, ethanol, a glycol, a hydrocarbon, a hydride, and/or a hydrogen-containing element.

Downstream of the plasma at point B (8), before cooling, oxidizing additives can optionally be added (if necessary).

1-5. (canceled)

6. A method for destroying effluents issuing from a reactor, the said effluents being transported through at least one pump and towards plasma means capable of destroying at least certain bonds in molecules of the PFC or HFC type between the fluorine and the other elements of theses molecules of the PC or HFC type, in order to generate first species which are then converted to second gaseous, liquid or solid species before interaction of these second species with dry or wet purifying means, wherein at least one hydrogen-containing reagent and/or reducing agent is injected downstream of the plasma, but upstream of the purifying means, in order to react with the first species created and form the second species, at least some of these second species being removable by wet purifying means such as a water scrubbing.

7. The method of claim 6, wherein at least one hydrogen-containing reagent and/or reducing agent is injected as early as possible into the plasma or into the post-discharge zone thereof.

8. The method of destroying effluents according to claim 6, wherein the hydrogen-containing reagent and/or reducing agent is selected from H₂O, NH₃, CH₄, and/or alcohols.

9. The method of claim 6, wherein at least one oxygen-containing compound is injected upstream of the plasma.

10. The method of claim 9, in which the effluents do not comprise elements which, by passage through the plasma, are capable of generating a metal deposit on the walls of the chamber where the plasma is generated, wherein the oxygen-containing compound injected upstream may also contain hydrogen atoms, while the injection of hydrogen-containing reagent and/or reducing agent may be maintained, reduced or even discontinued.
